(19) United States
(12) Patent Application Publication
(10) Pub. No.: US 2023/0278356 A1
(43) Pub. Date: Sep. 7, 2023

(54) PRINTING METHOD

(71) Applicant: HONDA MOTOR CO., LTD., Tokyo (JP)

(72) Inventors: Tohru Takamura, Tokyo (JP); Takaaki Nagata, Tokyo (JP); Tomohiko Shigihara, Tokyo (JP); Daisuke Kikuchi, Tokyo (JP); Toshio Kazami, Tokyo (JP)

(21) Appl. No.: 18/101,596

(22) Filed: Jan. 26, 2023

(30) Foreign Application Priority Data
Jan. 29, 2022 (CN) 202210112049.0

(51) Int. Cl. B41J 29/393

(52) U.S. Cl. CPC B41J 29/393

(57) ABSTRACT

A printing method for printing a first image and a second image on a printing object by using a print head while changing a relative position and a relative attitude of the print head relative to the print object, includes a first printing step of printing the first image on the printing object by using the print head; a processing step of performing an expansion and contraction processing on the second image so as to adjoin the first image printed on the printing object; and a second printing step of printing the second image that has been subjected to the expansion and contraction processing so as to adjoin the first image, on the printing object by using the print head.

### CROSS REFERENCE TO RELATED APPLICATIONS

This application is based upon and claims the benefit of priority from Chinese Patent Application No. 202210112049.0 filed on Jan. 29, 2022, the contents of which are incorporated herein by reference.

### BACKGROUND OF THE INVENTION

### Field of the Invention

The present invention relates to a printing method.

### Description of the Related Art

JP H07-137248 A discloses a printing method for printing a specific mark on a printing object (a printed material). The feed amount of the printing object and the deflection amount of ink droplets discharged from an electrostatic deflection type ink jet nozzle are adjusted according to the print position interval for the mark. Occurrence of white streaks or black streaks on a printed image is prevented.

### SUMMARY OF THE INVENTION

According to the printing method disclosed in JP H07-137248 A, there is a problem in that the printed mark may be distorted depending on the state of the printing surface and consequently the image quality may be impaired.

An object of the present invention is to solve the above-described problem.

According to an aspect of the invention, there is provided a printing method of printing a first image and a second image on a printing object by using a print head, while changing a relative position and a relative attitude of the print head relative to the printing object, the printing method including: a first printing step of printing the first image on the printing object by using the print head; a processing step of performing an expansion and contraction processing on the second image so as to adjoin the first image printed on the printing object, the expansion and contraction processing being configured to expand and contract an image; and a second printing step of printing the second image that has been subjected to the expansion and contraction processing so as to adjoin the first image, on the printing object by using the print head.

According to the present invention, it is possible to prevent white streaks or black streaks from occurring in printed images without impairing image quality.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a diagram illustrating how an image is printed on a printing object by a printing method according to an embodiment;

FIG. 2 is a diagram schematically illustrating a configuration of a gripping device, a printing device, and a storage device;

FIG. 3 is a diagram illustrating how a relative position and a relative attitude of a print head relative to the printing object change;

FIG. 4A is a diagram schematically illustrating a first image and a second image that adjoin each other;

FIG. 4B is a diagram schematically showing the first image that has been printed;

FIG. 4C is a diagram schematically illustrating an expansion and contraction processing of the second image;

FIG. 4D is a diagram schematically showing the first image and the second image printed so as to adjoin each other;

FIG. 5 is a flowchart illustrating a processing procedure for printing the first image and the second image on the printing object;

FIG. 6A is a diagram schematically illustrating a boundary line between a first image and a second image to be printed on a printing object by a printing method according to a first modification;

FIG. 6B is a diagram for explaining a position of one end of the first image that is in contact with the second image when the second image is subjected to the expansion and contraction processing;

FIG. 6C is a diagram for explaining the expansion and contraction processing of the second image which is performed with reference to the position of the one end of the first image;

FIG. 7A is a diagram for explaining a position of one end and a position of the other end of a first image that is in contact with a second image to be printed on a printing object by a printing method according to a second modification;

FIG. 7B is a diagram for explaining rotation correction of the second image which is performed with reference to the position of the one end of the first image; and

FIG. 7C is a diagram for explaining the expansion and contraction processing of the second image which is performed with reference to the position of the one end and the position of the other end of the first image.

### DETAILED DESCRIPTION OF THE INVENTION

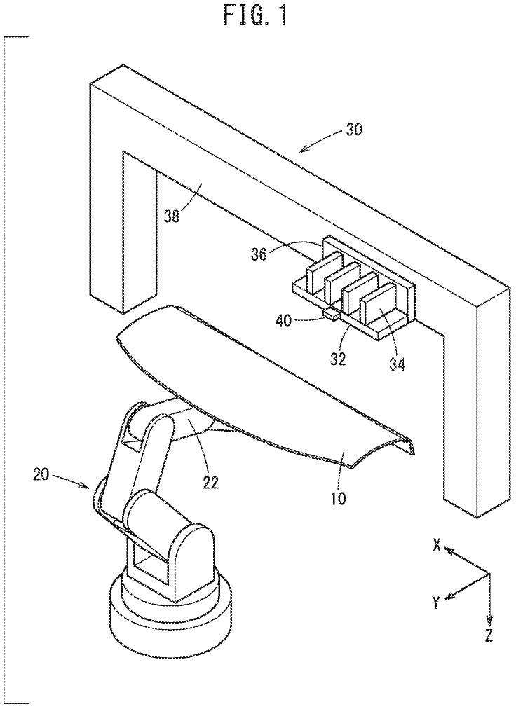

FIG. 1 is a diagram illustrating how an image is printed on a printing object (i.e., a material on which an image or the like is printed) 10 by a printing method according to an embodiment of the present invention. The printing object 10 is, for example, an interior panel used for the interior of an automobile. In the present embodiment, the printing object 10 has a printing surface of a non-flat three dimensional shape, but the printing object 10 may have a printing surface of a two dimensional shape. The printing object 10 is gripped by a gripping device 20. The gripping device 20 is, for example, a robot having a multi-axis articulated arm 22. A gripping portion (not shown) is attached to an end portion of the arm 22. The printing object 10 is gripped by the gripping portion.

A printing device 30 prints an image on the printing object 10. The printing device 30 includes a print head 32, a plurality of ink tanks 34, a carriage 36, a rail 38, and a sensor 40. The print head 32 includes a plurality of ink tanks 34 for different colors. Each ink tank 34 discharges ink droplets in the Z-axis direction (gravity direction) toward the printing surface of the printing object 10 during printing. The carriage 36 moves the print head 32 along the rail 38 during printing. The rail 38 extends linearly along the X-axis direction (horizontal direction). The Y-axis direction (horizontal direction) is orthogonal to the Z-axis direction and the X-axis direction.

The sensor 40 is provided in the print head 32. The sensor 40 is, for example, a camera. In the present embodiment, the detection process by the sensor 40 is an imaging process by a camera. The camera generates a captured image when capturing an image of the printing surface of the printing object 10.

When an image is printed on the printing object 10, droplets of ink (ink droplets) are discharged while the print head 32 moves along the rail 38. During the movement of the print head 32, the gripping device 20 moves the printing object 10 to thereby keep the distance between the print head 32 and the printing surface of the printing object 10 within a predetermined value. As a result, the relative position and the relative attitude of the print head 32 relative to the printing object 10 change. The relative position and the relative attitude of the print head 32 relative to the printing object 10 will hereinafter also be referred to simply as the relative position and the relative attitude of the print head 32, respectively.

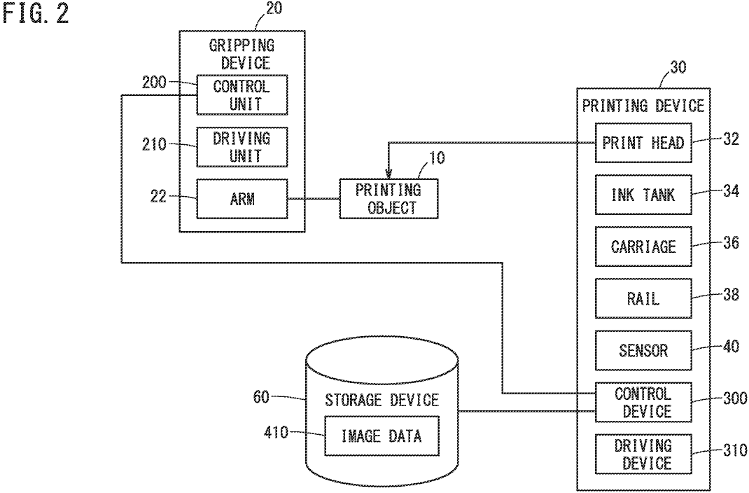

FIG. 2 is a diagram schematically illustrating a configuration of the gripping device 20, the printing device 30, and a storage device 60. The gripping device 20 is mounted on a movable base (not shown). The gripping device 20 further includes a control unit 200 and a driving unit 210 in addition to the arm 22 described above. The driving unit 210 is, for example, a motor.

The control unit 200 controls the driving unit 210 so that the driving unit 210 can move the arm 22. By moving the arm 22 in this way, the printing object 10 can be moved in various directions. The control unit 200 controls the driving unit 210, so that the driving unit 210 can move the gripping device 20. By moving the gripping device 20 in this way, the printing object 10 can be moved in the X-axis direction and the Y-axis direction. Instead of the driving unit 210, an external device of the gripping device 20 may move the gripping device 20.

The control unit 200 includes a processing circuit and a storage unit. The processing circuit includes a processor such as a CPU (Central Processing Unit). The storage unit includes a volatile memory such as a RAM (random access memory) and a non-volatile memory such as a ROM (read-only memory) and a flash memory. The storage unit stores programs and the like. When the processing circuit executes the program, the control unit 200 controls the arm 22 and the driving unit 210.

The printing device 30 further includes a control device 300 and a driving device 310. The driving device 310 is, for example, a motor. When an image is printed, the control device 300 controls the driving device 310 to thereby move the carriage 36 in the X-axis direction along the rail 38. Accordingly, the print head 32 moves in the X-axis direction along the rail 38. At the time of printing an image, the control device 300 further controls the print head 32 to discharge ink droplets from the ink tank 34 toward the printing surface of the printing object 10.

The control device 300 includes a processing circuit and a storage unit. The processing circuit includes a processor such as a CPU (Central Processing Unit). The storage unit includes a volatile memory such as a RAM (random access memory) and a non-volatile memory such as a ROM (read-only memory) and a flash memory. The storage unit stores programs and the like. When the processing circuit executes the program, the control device 300 controls the print head 32, the sensor 40, and the driving device 310 and communicates with the control unit 200 of the gripping device 20.

The storage device 60 stores image data 410. The image data 410 is data of an image to be printed on the printing object 10. The control device 300 of the printing device 30 prints an image on the printing object 10, based on the image data 410.

The control device 300 controls the print head 32 and the driving device 310 to print the image on the printing object 10. At this time, the driving device 310 moves the print head 32 in the X-axis direction. In addition, when the control device 300 communicates with the control unit 200 of the gripping device 20, the control unit 200 controls the driving unit 210 to move the printing object 10. In this way, the images are successively printed on the printing object 10 while the relative position and the relative attitude of the print head 32 relative to the printing object 10 are changed, in accordance with the program.

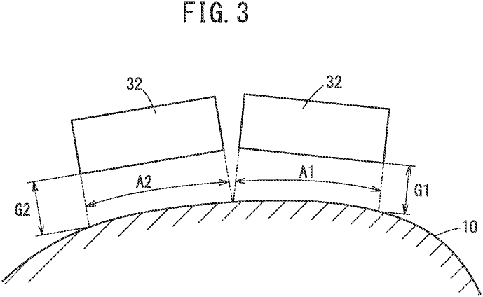

FIG. 3 is a diagram illustrating how the relative position and the relative attitude of the print head 32 relative to the printing object 10 change. The image data 410 includes data of a first image and a second image that adjoin each other. In FIG. 3, the first image and the second image are printed respectively in a first region A1 and a second region A2 of the printing surface of the printing object 10, in a manner of adjoining each other. The printing surface of the printing object 10 has a non-flat three dimensional shape.

The relative position of the print head 32 when the first image is printed in the first region A1 is set to a position substantially directly above the first region A1. In this case, the relative attitude of the print head 32 is set such that the value of the distance G1 between the print head 32 and the first region A1 is within a predetermined value G0. After the first image has been printed in the first region A1, the relative position of the print head 32 is moved by the movement of the printing object 10, and the second image is then printed in the second region A2.

The relative position of the print head 32 when the second image is printed in the second region A2 is set to a position substantially directly above the second region A2. In this case, the relative attitude of the print head 32 is set such that the value of the distance G2 between the print head 32 and the second region A2 is within the above predetermined value G0. The relative position and the relative attitude of the print head 32 when the first image is printed are different from the relative position and the relative attitude of the print head 32 when the second image is printed.

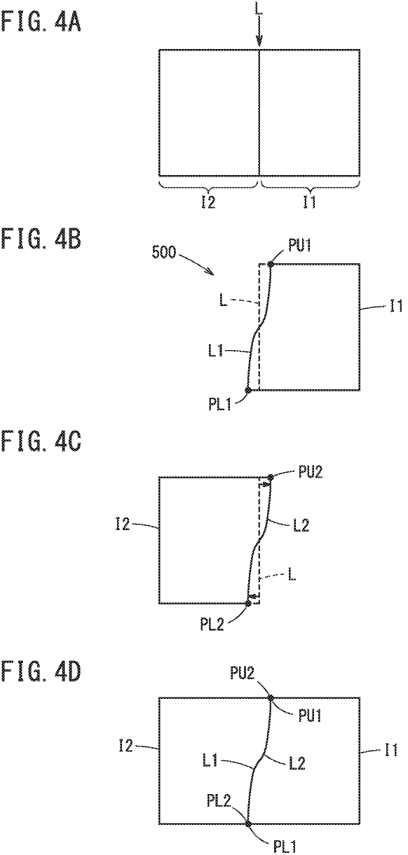

FIG. 4A is a diagram schematically showing a first image I1 and a second image I2 that adjoin each other. The first image I1 and the second image I2 are, for example, images of a wood-grain pattern. In a case where the contour of the first image I1 and the contour of the second image I2 are both rectangular, the boundary line L between the first image I1 and the second image I2 is formed into a linear shape.

The first image I1 and the second image I2 are printed on a printing surface having a non-flat three dimensional shape. In this case, there is a possibility that the printed first image I1 may be deformed despite the printing according to the program. When the first image I1 is deformed, a line of the first image I1 that should serve as a boundary line between the first image I1 and the second image I2 may be distorted and consequently may not be linear.

If the first image I1 and the second image I2 do not precisely adjoin each other, a white streak or a black streak may occur in the printed image. It is necessary that a line of the first image I1 to be a boundary line between the first image I1 and the second image I2 and a line of the second image I2 to be a boundary line therebetween substantially coincide with each other. Therefore, in the present embodiment, the second image I2 is subjected to an expansion and contraction processing for expanding and contracting an image, in accordance with the deformation of the first image I1.

FIG. 4B is a diagram schematically showing the first image I1 that has been printed. The first image I1 is printed on the printing surface of the printing object 10, at the relative position and the relative attitude of the print head 32 used when the first image I1 is printed. Note that a line of the first image I1 that should serve as a boundary line between the first image I1 and the second image I2 is referred to as a boundary line L1.

As a specific operation, the control device 300 of the printing device 30 acquires data of the first image I1 from the image data 410. The control device 300 controls the print head 32 and the driving device 310 while communicating with the control unit 200 of the gripping device 20 to thereby print the first image I1 on the printing object 10. The printing object 10 is set so as to be in an attitude used when the first image I1 is printed, by the gripping device 20.

When the first image I1 is printed, the relative position and the relative attitude of the print head 32 change. At the relative position and the relative attitude of the print head 32 when the second image I2 is printed, the first image I1 is detected by means of the sensor 40 provided on the print head 32. To be specific, the printed first image I1 is captured by the camera to thereby obtain a captured image 500. Based on the captured image 500, the second image I2 is subjected to the expansion and contraction processing such that the second image I2 adjoins the first image I1.

In the example shown in FIG. 4B, the boundary line L1 of the first image I1 when the printed first image I1 adjoins the second image I2 is distorted because the printing surface is not flat. Therefore, the boundary line L1 of the first image I1 which is supposed to be in contact with the second image I2 does not coincide with the original boundary line L. An end point PL1 and an end point PU1 are located at the position of one end and the position of the other end of the boundary line L1, respectively. In FIG. 4B, the end point PL1 is at a position that is shifted over the original boundary line L and toward the second image I2. The end point PU1 is at a position that is away from the original boundary line L and retreated from the second image I2.

FIG. 4C is a diagram schematically illustrating the expansion and contraction processing of the second image I2. On the basis of the captured image 500 described above, the second image I2 is subjected to the expansion and contraction processing so as to adjoin the first image I1 printed on the printing object 10. The boundary line L2 of the second image I2 which is supposed to be in contact with the first image I1 coincides with the original boundary line L before the expansion and contraction processing. The second image I2 is subjected to the expansion and contraction processing such that the boundary line L2 coincides with the above-described boundary line L1 of the first image I1. When an image is printed on a non-flat printing surface, the image receives only a minute deformation. Accordingly, if the degree to which the expansion and contraction processing is performed is so small as to only cause the boundary line L1 and the boundary line L2 to coincide with each other, a feeling of strangeness with respect to the processed image is unlikely to occur.

An end point PL2 and an end point PU2 are located at the position of one end and the position of the other end, of the boundary line L2 of the second image I2, respectively. The second image I2 is subjected to the expansion and contraction processing with the original boundary line L as a reference. As shown in FIG. 4C, the end point PL2 is located at a position that is away from the original boundary line L and that recedes from the first image I1, so as to coincide with the above-described end point PL1. The end point PU2 is located at a position that is shifted over the original boundary line L and toward the first image I1, so as to coincide with the above-described end point PU1.

As a specific operation, the control device 300 of the printing device 30 acquires the captured image 500 of the first image I1 including the distortion (deformation) of the boundary line L1 by using the sensor 40. The control device 300 detects the distortion of the boundary line L1 of the first image I1 based on the captured image 500. The control device 300 acquires the second image I2 from the image data 410. The control device 300 performs the expansion and contraction processing on the second image I2 in accordance with the distortion of the boundary line L1.

FIG. 4D is a diagram schematically showing the first image I1 and the second image I2 printed so as to adjoin each other. After the second image I2 has been subjected to the expansion and contraction processing, the second image I2 subjected to the expansion and contraction processing is printed on the printing surface of the printing object 10 at the relative position and the relative attitude of the print head 32 used when the second image I2 is printed. Thus, the second image I2 is printed so as to adjoin the first image I1.

As a specific operation, the control device 300 controls the print head 32 and the driving device 310 while communicating with the control unit 200 of the gripping device 20 to thereby print the second image I2 on the printing object 10. The printing object 10 is set so as to be in an attitude used when the second image I2 is printed, by the gripping device 20.

As a result, as shown in FIG. 4D, the boundary line L1 of the first image I1 that should adjoin the second image I2 can be made to coincide with the boundary line L2 of the second image I2 that should adjoin the first image I1. The end point PL1 and the end point PU1 of the boundary line L1 coincide with the end point PL2 and the end point PU2 of the boundary line L2, respectively.

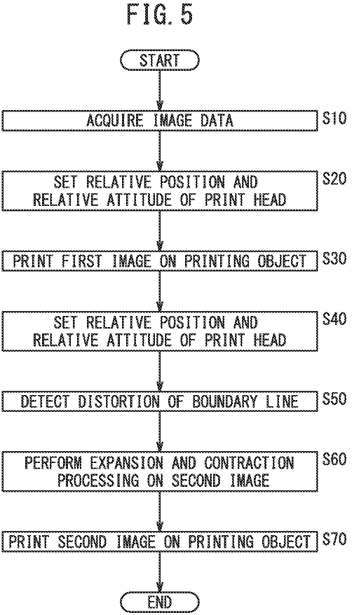

FIG. 5 is a flowchart illustrating a processing procedure for printing the first image I1 and the second image I2 on the printing object 10. This processing procedure is performed by, for example, the processing circuit included in the control device 300 of the printing device 30 executing a program. When this processing procedure is started, in step S10, the control device 300 acquires the image data 410 from the storage device 60. That is, the control device 300 acquires data of the first image I1 and the second image I2.

In step S20, the control device 300 controls the print head 32 to set the relative position and the relative attitude of the print head 32 relative to the printing object 10. The relative position and the relative attitude of the print head 32 are set to the relative position and the relative attitude of the print head 32 used when the first image I1 is printed. In step S30, the control device 300 controls the print head 32 to print the first image I1 on the printing surface of the printing object 10.

In step S40, the control device 300 controls the print head 32 to set the relative position and the relative attitude of the print head 32 relative to the printing object 10. The relative position and the relative attitude of the print head 32 are set to the relative position and the relative attitude of the print head 32 used when the second image I2 is printed. In step S50, the control device 300 controls the sensor 40 to detect the distortion of the boundary line L1 of the first image I1.

In step S60, the control device 300 performs the expansion and contraction processing on the second image I2 so as to adjoin the first image I1 printed on the printing surface of the printing object 10. The second image I2 is subjected to the expansion and contraction processing in accordance with the deformation of the first image I1 caused by being printed on the printing surface of a three dimensional shape. The deformation of the first image I1 is, for example, a distortion of the detected boundary line L1.

In Step S70, the control device 300 controls the print head 32 to print the second image I2 subjected to the expansion and contraction processing, on the printing surface of the printing object 10. Thus, the second image I2 is printed so as to adjoin the first image I1. When the processing of step S70 is completed, this processing procedure is ended.

### Modifications

The above-described embodiment may be modified as follows.

### (Modification 1)

In the above-described embodiment, before the expansion and contraction processing, the boundary line L2 of the second image I2 which should be in contact with the first image I1 coincides with the original boundary line L. As shown in FIG. 4C, the second image I2 is subjected to the expansion and contraction processing such that the boundary line L2 coincides with the distorted boundary line L1 of the first image I1 which should be in contact with the second image I2. Alternatively, the second image I2 may be subjected to the expansion and contraction processing with reference to the end point PL1 located at the one end of the boundary line L1 of the first image I1.

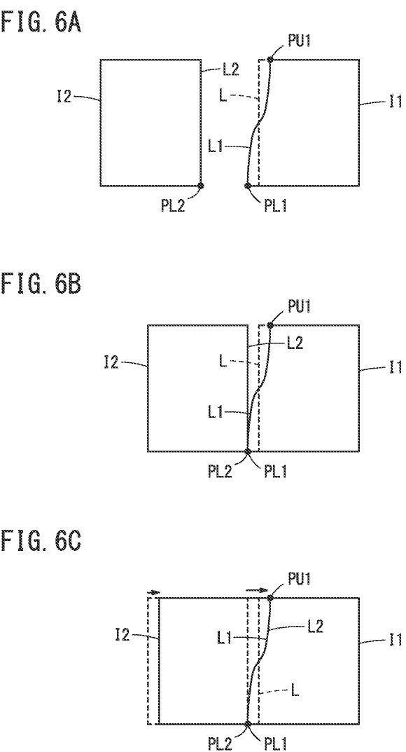

FIG. 6A is a diagram schematically illustrating the boundaries L, L1, L2 between the first image I1 and the second image I2 to be printed on the printing object 10 by a printing method according to a first modification. Similar to FIG. 4B, in FIG. 6A, the boundary line L1 of the printed first image I1 is distorted. The end point PL1 is located at a position of one end of the boundary line L1 of the first image I1. In FIG. 6A, the second image I2 before the expansion and contraction processing is also shown. The end point PL2 is located at the position of one end of the boundary line L2 of the second image I2.

FIG. 6B is a diagram for explaining a position of one end (end point PL1) of the first image I1 that is in contact with the second image I2 when the second image I2 is subjected to the expansion and contraction processing. In the present modification, the second image I2 is subjected to the expansion and contraction processing with reference to the position of the end point PL1 of the first image I1. For the process, the second image I2 before the expansion and contraction processing is placed such that the position of the end point PL2 of the second image I2 before the expansion and contraction processing coincides with the position of the end point PL1 of the first image I1.

FIG. 6C is a diagram for explaining the expansion and contraction processing of the second image I2 which is performed with reference to the position of the one end (end point PL1) of the first image I1. On the basis of the captured image 500 described above, the second image I2 is subjected to the expansion and contraction processing so as to adjoin the first image I1 printed on the printing object 10. The boundary line L2 of the second image I2 coincides with the boundary line L1 of the first image I1. When the second image I2 subjected to the expansion and contraction processing is printed on the printing surface of the printing object 10, the second image I2 is printed so as to adjoin the first image I1. Note that the second image I2 may be further subjected to the expansion and contraction processing such that the total size of the first image I1 and the second image I2 after printing is substantially equal to the total size before printing.

### (Modification 2)

Unlike the above-described embodiment and Modification 1, the second image I2 may be subjected to the expansion and contraction processing with reference to the end point PL1 and the end point PU1 located at the position of one end and the position of the other end of the boundary line L1 of the first image I1.

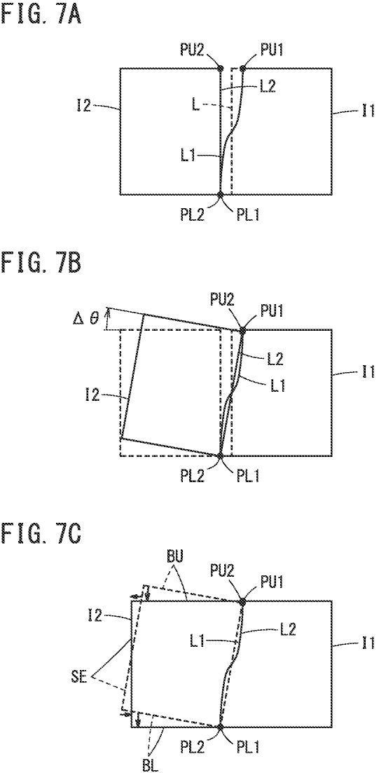

FIG. 7A is a diagram for explaining a position of one end (end point PL1) and a position of the other end (end point PU1) of the first image I1 that is supposed to be in contact with the second image I2 to be printed on the printing object 10 by a printing method according to a second modification. Similarly to FIG. 4C and FIG. 6A, in FIG. 7A, the boundary line L1 of the printed first image I1 is distorted. The end point PL1 is located at a position of one end of the boundary line L1 of the first image I1. The end point PU1 is located at a position of the other end of the boundary line L1 of the first image I1.

In FIG. 7A, the second image I2 before the expansion and contraction processing is also shown. The end point PL2 is located at the position of one end of the boundary line L2 of the second image I2. The end point PU2 is located at the position of the other end of the boundary line L2 of the second image I2. In the present modification, the second image I2 is subjected to the expansion and contraction processing with reference to the position of the end point PL1 of the first image I1 and the position of the end point PU1. The second image I2 before the expansion and contraction processing is placed such that the position of the end point PL2 of the second image I2 before the expansion and contraction processing coincides with the position of the end point PL1 of the first image I1.

FIG. 7B is a diagram for explaining rotation correction of the second image I2 which is performed with reference to the position of the one end (end point PL1) of the first image I1. With reference to the position of the end point PL1 of the first image I1, the second image I2 before the expansion and contraction processing is rotated by a minute angle Δθ Since the angle Δθ is very small, the position of the end point PU2 of the second image I2 substantially coincides with the position of the end point PU1 of the first image I1. Since the boundary line L2 of the second image I2 after the rotation correction is linear, the boundary line L2 does not coincide with the boundary line L1 of the first image I1.

FIG. 7C is a diagram for explaining the expansion and contraction processing of the second image I2 which is performed with reference to the position of the one end (end point PL1) and the position of the other end (end point PU1) of the first image I1. On the basis of the captured image 500 described above, the second image I2 is subjected to the expansion and contraction processing so as to adjoin the first image I1 printed on the printing object 10. By the expansion and contraction processing of the second image I2, the boundary line L2 of the second image I2 coincides with the boundary line L1 of the first image I1. When the second image I2 subjected to the expansion and contraction processing is printed on the printing surface of the printing object 10, the second image I2 is printed so as to adjoin the first image I1.

In the present modification, the degree to which the expansion and contraction processing is performed in order to cause the boundary line L2 of the second image I2 to coincide with the boundary line L1 of the first image I1 is relatively small as compared with the above-described embodiment and Modification 1. Further, as described above, the angle Δθ by which the second image I2 is rotated relative to the first image I1 is minute. Therefore, a feeling of strangeness with respect to the processed image is unlikely to occur.

The expansion and contraction processing of the second image I2 is not limited to causing the boundary line L2 of the second image I2 to coincide with the boundary line L1 of the first image I1. In a case where the contours of the first image I1 and the second image I2 before the expansion and contraction processing are rectangular, the upper base BU, the lower base BL, and the side SE of the contour of the second image I2 are inclined by the angle Δθ relative to the contour of the first image I1. Therefore, as shown in FIG. 7C, the expansion and contraction processing may be performed to make the inclination angle Δθ zero. The side SE is an opposite side of the boundary line L2 of the second image I2.

Note that the present invention is not limited to the above-described embodiment and modifications, and various configurations can be adopted without departing from the gist of the present invention.

### Invention Obtained From Embodiment

The invention that can be grasped from the above-described embodiment and modifications will be described below.

(1) The printing method of printing the first image (I1) and the second image (I2) on the printing object (10) by using the print head (32), while changing the relative position and the relative attitude of the print head relative to the printing object, includes: a first printing step of printing the first image on the printing object by using the print head; a processing step of performing an expansion and contraction processing on the second image so as to adjoin the first image printed on the printing object, the expansion and contraction processing being configured to expand and contract an image; and a second printing step of printing the second image that has been subjected to the expansion and contraction processing so as to adjoin the first image, on the printing object by using the print head. With this configuration, it is possible to prevent white streaks or black streaks from occurring in a printed image without impairing image quality.

(2) The printing object may have a printing surface having a non-flat three dimensional shape, and in the processing step, the second image may be subjected to the expansion and contraction processing in accordance with deformation of the first image, the deformation being caused as a result of printing the first image on the printing surface having the non-flat three dimensional shape. With this configuration, even in a case where the printing object has a printing surface having a non-flat three dimensional shape, it is possible to prevent white streaks or black streaks from occurring in the printed image.

(3) The printing method may further include: a detecting step of detecting distortion of a boundary line (L1) of the first image that adjoins the second image, with the sensor (40) provided on the print head, at the relative position and the relative attitude of the print head used when the second image is printed, and in the processing step, the second image may be subjected to the expansion and contraction processing in accordance with the distortion of the boundary line that has been detected. With this configuration, it is possible to accurately prevent white streaks or black streaks from occurring in the printed image.

(4) The sensor may be a camera, and in the detecting step, the distortion of the boundary line may be detected based on an image (500) captured by the camera. With this configuration, it is possible to accurately prevent white streaks or black streaks from occurring in the printed image.

(5) In the processing step, the second image may be subjected to the expansion and contraction processing with reference to a position of at least one end (PL1) of the first image that is in contact with the second image. With this configuration, it is possible to prevent white streaks or black streaks from occurring in the printed image without a sense of discomfort.

What is claimed is:

1. A printing method of printing a first image and a second image on a printing object by using a print head, while changing a relative position and a relative attitude of the print head relative to the printing object, the printing method comprising:
a first printing step of printing the first image on the printing object by using the print head;
a processing step of performing an expansion and contraction processing on the second image so as to adjoin the first image printed on the printing object, the expansion and contraction processing being configured to expand and contract an image; and
a second printing step of printing the second image that has been subjected to the expansion and contraction processing so as to adjoin the first image, on the printing object by using the print head.

2. The printing method according to claim 1, wherein
the printing object has a printing surface having a non-flat three dimensional shape, and
in the processing step, the second image is subjected to the expansion and contraction processing in accordance with deformation of the first image, the deformation being caused as a result of printing the first image on the printing surface having the non-flat three dimensional shape.

3. The printing method according to claim 1, further comprising:
a detecting step of detecting distortion of a boundary line of the first image that adjoins the second image, with a sensor provided on the print head, at the relative position and the relative attitude of the print head used when the second image is printed,
wherein, in the processing step, the second image is subjected to the expansion and contraction processing in accordance with the distortion of the boundary line that has been detected.

4. The printing method according to claim 2, further comprising:
a detecting step of detecting distortion of a boundary line of the first image that adjoins the second image, with a sensor provided on the print head, at the relative position and the relative attitude of the print head used when the second image is printed,
wherein, in the processing step, the second image is subjected to the expansion and contraction processing in accordance with the distortion of the boundary line that has been detected.

5. The printing method according to claim 3, wherein
the sensor is a camera, and
in the detecting step, the distortion of the boundary line is detected based on an image captured by the camera.

6. The printing method according to claim 4, wherein
the sensor is a camera, and
in the detecting step, the distortion of the boundary line is detected based on an image captured by the camera.

7. The printing method according to claim 1, wherein
in the processing step, the second image is subjected to the expansion and contraction processing with reference to a position of at least one end of the first image that is in contact with the second image.
